(19) United States
(12) Patent Application Publication
(10) Pub. No.: US 2016/0379214 A1
(43) Pub. Date: Dec. 29, 2016

(54) PRIVACY PROTECTION IN ECOMMERCE/LOGISTICS

(71) Applicant: International Business Machines Corporation, Armonk, NY (US)

(72) Inventors: Min LI, Beijing (CN); Changhua SUN, Beijing (CN); Li BJ ZHANG, Beijing (CN); Shiwan ZHAO, Beijing (CN)

(21) Appl. No.: 14/750,529

(22) Filed: Jun. 25, 2015

(51) Int. Cl. G06Q 20/40; G06K 7/14; G06Q 10/08

(52) U.S. Cl. CPC G06Q 20/401; G06Q 10/083; G06K 7/1417; G06Q 2220/00

(57) ABSTRACT

Various embodiments secure a customer's private data within a logistics environment. In one embodiment, a graphical object including encoded data associated with an order for goods is generated. The encoded data within the graphical object is machine-only readable. An electronic shipping form is generated. The electronic shipping form includes at least a delivery address associated with the order and the graphical object. Private data associated with a customer is inaccessible to a human via the electronic shipping form. The electronic shipping form is wirelessly transmitted to an electronic device associated with a delivery person.

### BACKGROUND

The present disclosure generally relates to securing data, and more particularly relates to securing customers' private data within e-commerce and logistics environments.

E-commerce transactions generally require a user to enter personal information such as his/her name, telephone number, and/or the like. The user's private information is usually provided to the logistics company who will deliver the ordered goods. This raises various privacy concerns since the delivery person has access to the user's private information. Conventional e-commerce and logistics systems generally do not provide any safeguards against these privacy issues.

### BRIEF SUMMARY

In one embodiment, a method for securing private data in a logistics environment is disclosed. The method comprises generating a graphical object comprising encoded data associated with an order for goods. The encoded data within the graphical object is machine-only readable. An electronic shipping form is generated. The electronic shipping form comprises at least a delivery address associated with the order and the graphical object. Private data associated with a customer is inaccessible to a human via the electronic shipping form. The electronic shipping form is wirelessly transmitted to an electronic device associated with a delivery person.

In another embodiment, an information processing system for securing private data in a logistics environment is disclosed. The information processing system memory and a processor that is operably coupled to the memory. The information processing system further comprises at a logistics manager. The information processing system is operably coupled to the memory, the processor, and the application, and is configured to perform a method. The method comprises generating a graphical object comprising encoded data associated with an order for goods. The encoded data within the graphical object is machine-only readable. An electronic shipping form is generated. The electronic shipping form comprises at least a delivery address associated with the order and the graphical object. Private data associated with a customer is inaccessible to a human via the electronic shipping form. The electronic shipping form is wirelessly transmitted to an electronic device associated with a delivery person.

In yet another embodiment, a computer program product for securing private data in a logistics environment is disclosed. The computer program product comprises a storage medium readable by a processing circuit and storing instructions for execution by the processing circuit for performing a method. The method comprises generating a graphical object comprising encoded data associated with an order for goods. The encoded data within the graphical object is machine-only readable. An electronic shipping form is generated. The electronic shipping form comprises at least a delivery address associated with the order and the graphical object. Private data associated with a customer is inaccessible to a human via the electronic shipping form. The electronic shipping form is wirelessly transmitted to an electronic device associated with a delivery person.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram illustrating one example of an operating environment according to one embodiment of the present disclosure;

FIG. 2 illustrates one example of order data according to one embodiment of the present disclosure;

FIG. 3 illustrates an order form comprising a portion of the order data in FIG. 2 according to one embodiment of the present disclosure;

FIG. 4 illustrates one example of customer data according to one embodiment of the present disclosure;

FIG. 5 illustrates an shipping order form according to one embodiment of the present disclosure;

FIG. 6 illustrates an interface for allowing a delivery person to anonymously communication with a customer form according to one embodiment of the present disclosure;

FIG. 7 illustrates another interface for allowing a delivery person to anonymously communication with a customer form according to one embodiment of the present disclosure;

FIGS. 8-10 are operational flow diagrams illustrating various examples of securing customer private data within a logistics environment according to one embodiment of the present disclosure; and

FIG. 11 is a block diagram illustrating one example of an information processing system according to one embodiment of the present disclosure.

### DETAILED DESCRIPTION

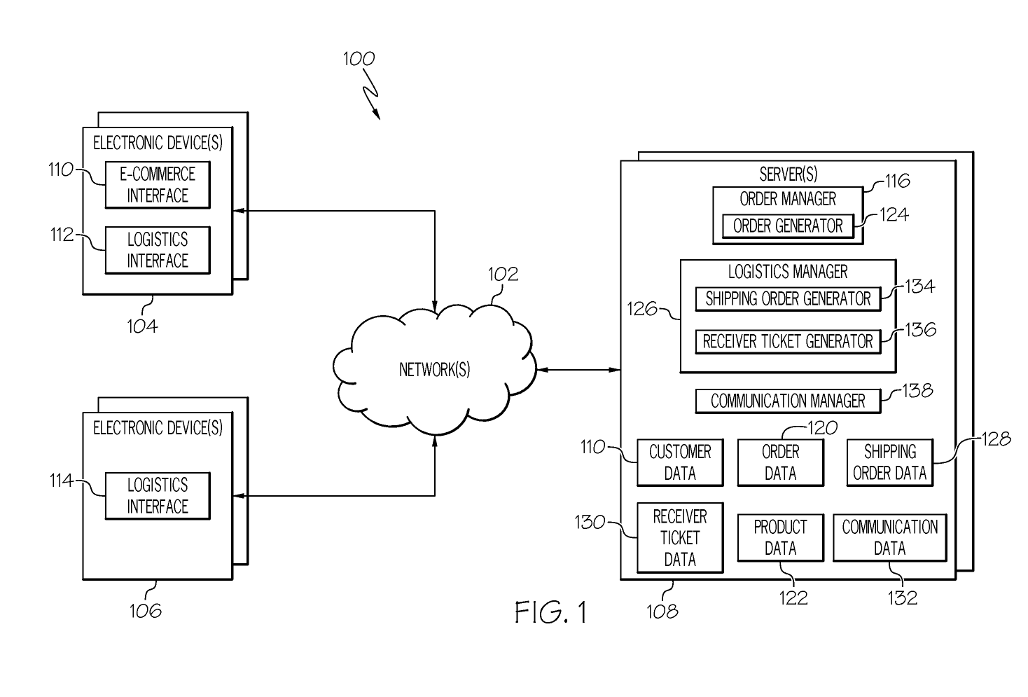

FIG. 1 shows an operating environment 100 for protecting private data in e-commerce settings according to one embodiment of the present disclosure. The operating environment 100 comprises at least one network 102. The network(s) 102 comprises cloud and/or non-cloud based technologies, wireless communication networks, non-cellular networks such as Wireless Fidelity (WiFi) networks, public networks such as the Internet, private networks, and/or the like. The wireless communication networks support any wireless communication standard such as, but not limited to, Global System for Mobile Communications (GSM), Code Division Multiple Access (CDMA), Time Division Multiple Access (TDMA), General Packet Radio Service (GPRS), Frequency Division Multiple Access (FDMA), Orthogonal Frequency Division Multiplexing (OFDM), or the like. The wireless communication networks include one or more networks based on such standards. For example, in one embodiment, a wireless communication network comprises one or more of a Long Term Evolution (LTE) network, LTE Advanced (LTE-A) network, an Evolution Data Only (EV-DO) network, a General Packet Radio Service (GPRS) network, a Universal Mobile Telecommunications System (UMTS) network, and the like.

FIG. 1 further shows that a plurality of electronic devices 104, 106 and one or more server-based information processing systems 108 are communicatively coupled to the network 102. The electronic devices 104, 106, in this embodiment, are information processing systems such as desktop and portable computing devices and/or wireless communication devices. Examples of wireless communication devices include two-way radios, cellular telephones, mobile phones, smartphones, two-way pagers, wireless messaging devices, wearable computing devices, tablet computers, personal digital assistants, and other similar devices.

In one embodiment, at least a first of the electronic devices 104 is associated with a user/customer that has placed an order for one or more goods through one of the servers 108 providing an e-commerce environment. This user device 104 comprises at least an e-commerce interface 110 and a logistics interface 112. The e-commerce interface 110 enables the user to communicate and interact with the e-commerce sever 108. The logistics interface 112 enables the user to communicate and interact with a logistics environment provided by the server 108 or another server. Each of the interfaces 110, 112 can be a dedicated e-commerce or logistics-based application, an application such as a web browser, a communication-based application, and/or the like. It should be noted that, in some embodiments, the e-commerce and logistics interfaces 110, 112 are part of a single interface. At least a second of the electronic devices 106 is associated with a logistics-based user such as a courier, delivery driver, and/or the like. This user device 106 comprises a logistics interface 114. Each of the e-commerce and logistics interfaces 110, 112, 114 is discussed in greater detail below.

As discussed above, at least one of the server-based information processing systems 108 provides an e-commerce environment. A user interacts with the server 108 to electronically order at least one good offered by one or more entities through the user's e-commerce interface 110. Alternatively, the user is able to communicate with one or more individuals at the entity to place his/her order. In this embodiment, the individual electronically enters the order information into the e-commerce environment.

The server 108 comprises an order manager 116, customer data 118, order data 120, and product data 122. The order manager 116 manages all orders placed through the server 108, and comprises an order generator 124. The order generator 124 generates the actual order for the product requested by a user, and is discussed in greater detail below. The customer data 118 comprises information associated with customers who have placed orders through the server 108. The order data 120 comprises order records representing orders placed by customers. The product data 122 comprises information associated with each product offered through the server 108. The customer data 118, order data 120, and product data 122 are discussed in greater detail below.

In one embodiment, the server 108 also provides a logistics environment. However, the logistics environment can also be provided by another server system as well. The server 108, in one embodiment, provides a logistics environment through which shipping/delivery of a customer's goods is managed. The server 108 comprises a logistics manager 126, shipping order data 128, receiver ticket data 130, and communication data 132. The logistics manager 126 comprises a shipping order generator 134, and a receiver ticket generator 136. The server 108 also comprises a communication manager 138, which can be part of the order manager 116 and/or the logistics manager 126. Each of these components is discussed in greater detail below. It should be noted that, in some embodiments, one or more components and operations associated with manager customer orders can reside on and be performed by an information processing system that is separate and distinct from the system comprising and performing one or more of the logistics components and operations. Also, the communication manager 138 can be disposed within a communication server that is separate and distinct from the server 108 and the server 108.

As discussed above, most conventional e-commerce and logistics systems generate shipping orders/forms with a customer's private information being accessible by the delivery person. For example, many conventional shipping orders/forms are generated with a customer's name and phone number being viewable by the delivery person. This can cause privacy concerns when a customer may want his/her personal information kept private. Therefore, one or more embodiments generate shipping orders/forms that protect customers' private information by making this information inaccessible to a delivery person.

In one embodiment, a user establishes a communication session with the server 108 via the e-commerce interface 110 on his/her user device 104. Once the communication session has been established, the user is able to interact with the server. For example, the user can browse an online store and select one or more products to purchase. The user selects an option via the interface 110 to electronically submit an order request to the server 108. The order request comprises, for example, user identifying information such as a unique identifier generated by the order manager 116 (or other component of the server 108); user first and last names; user billing address; user private address; user delivery address; user payment information; and/or the like.

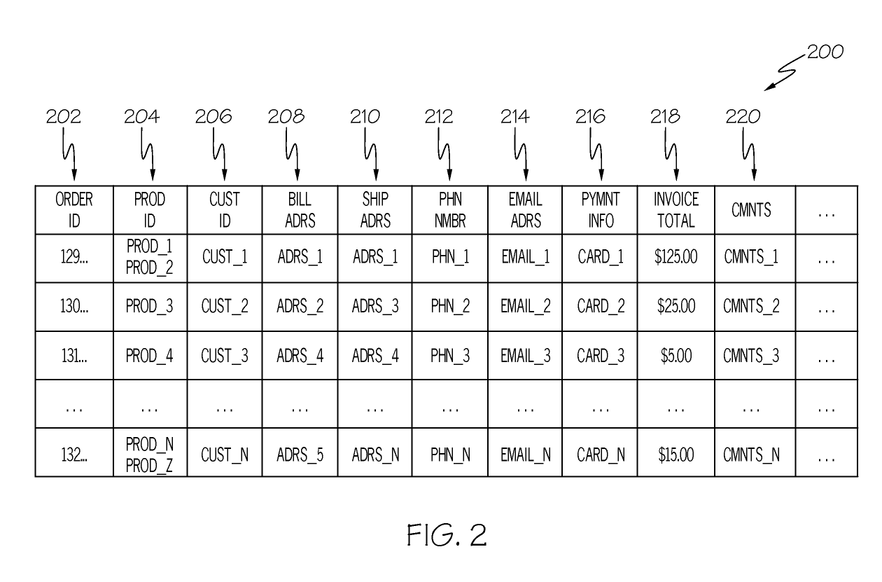

The order manager 116 at the server 108 receives the order request submitted by the user. The order generator 124 extracts the data from the order request and generates an order record, which is stored as order data 120. FIG. 2 shows one example of order records. In particular, FIG. 2 shows a table 200 comprising a plurality of rows and columns. Each row represents a single order record, while each column represents a specific attribute of a record. In this example, each record comprises an order identifier (ID) 202, a product ID 204, a customer ID 206, a customer billing address 208, a customer shipping address 210, a customer phone number 212, an customer email address 214, customer payment information 216, order/invoice total 218, and order comments 220. It should be noted that an order record can be associated with other attributes as well.

The order ID 202 is a unique identifier associated with a given order. Product IDs 204 are uniquely identify each product offered for sale by an entity through the server 108. Product IDs 204 can be utilized to obtain product descriptions, product pricing, product availability, and/or the like from the product data 122. Customer IDs 206 uniquely represent a customer. In one embodiment, a customer ID 206 is linked to (or points to) a set of customer data 120 (e.g., one or more customer records) associated with a given customer. A customer ID can be transmitted as part of an order request or can be associated with a user upon receiving the order request. In some embodiments, a user is assigned the same unique identifier each time he/she interacts with the server 108. Returning users can be identified based on their login and session information. In another embodiment, the order generator 124 identifies a returning user based on various information provided by the user in the order request. In this embodiment, the order manager 116 assigns a unique identifier to (or identifies the unique identifier associated with) the user once the order request has been received.

Billing address information 208 comprises the address associated with the payment information provided by the customer. Shipping address information 210 comprises the address to which the order is to be delivered. Phone number information 212 comprises the phone number(s) at which the customer can be contacted. Email address information 214 comprises the email address(es) at which the customer can be contacted. It should be noted that, in some embodiments, one or more of the billing address information 208, shipping address information 210, phone number information 212, and email address information 214 can be provided by the customer in the order request and/or obtained from a customer record within the customer data 118. Payment information 216 comprises the payment type, account number, expiration date, verification data of the payment provided by the customer for the order. Invoice total information 218 comprises a total payment amount required from the customer and/or itemized amounts for each product ordered by the customer. Comments 220 allow for free-form information to be added to the order such as special shipping/delivery instructions, salesperson notes, and/or the like.

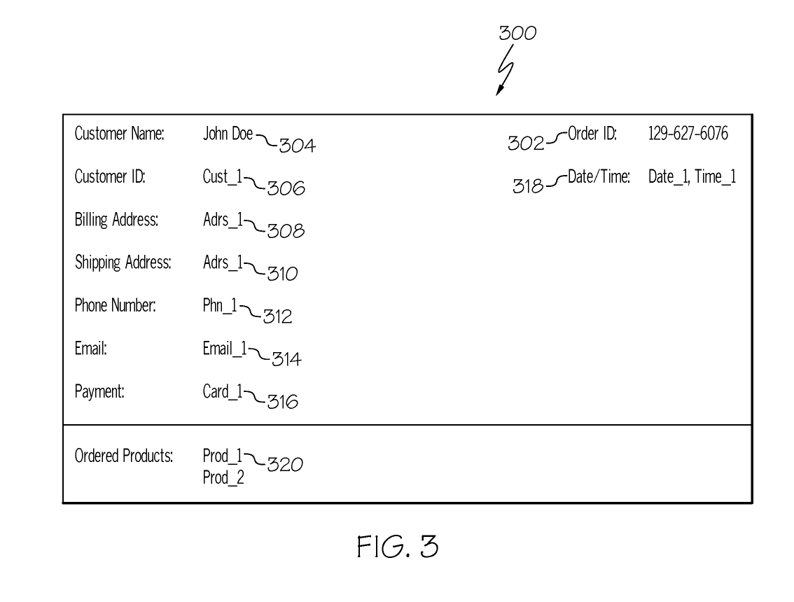

In one embodiment, the order generator 124 utilizes customer data 118 and order data 120 to generate a graphical representation of an order. FIG. 3 shows one example of a graphical representation 300 of an order. The graphical representation 300 can be presented to the user via the user device 104. In one embodiment, the graphical representation 300 comprises information from an order record and, optionally, a customer record. For example, FIG. 3 shows that the graphical representation 300 comprises an order ID 302; the customer's name 304, unique ID 306, billing address 308; shipping address 310; phone number 312; email 314; payment information 316; the date and time 318 the order was placed; and an identification 320 of the ordered products.

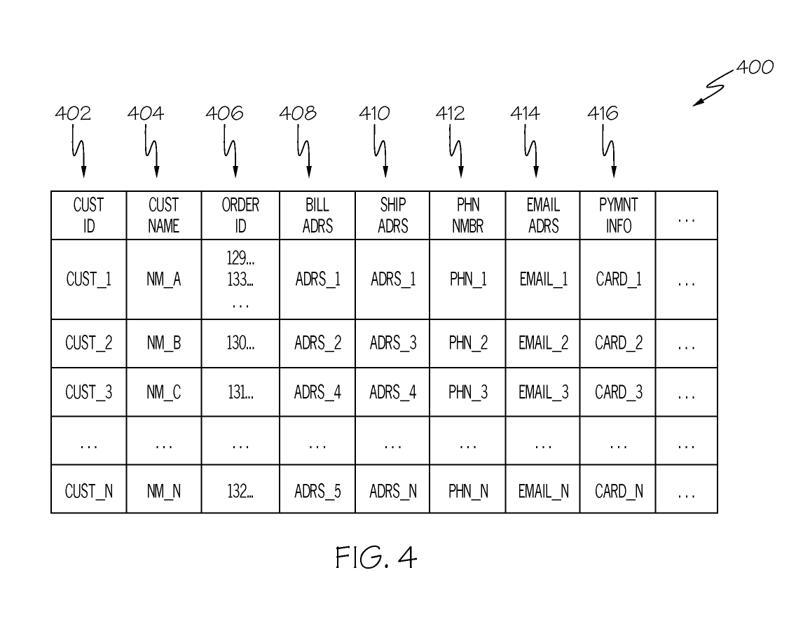

In addition to generating an order record, the order generator 124 updates and/or creates customer records based on the information extracted from the order request or any other information provided by the user external to the order request. In one embodiment, customer records are stored as customer data 118. FIG. 4 shows one example of customer records. In particular, FIG. 4 shows a table 400 comprising a plurality of rows and columns. Each row represents a single order record, while each column represents a specific attribute of a record. In this example, each record comprises a customer ID 402, the customer's name 404, an order identifier (ID) 406, a customer billing address 408, a customer shipping address 410, a customer phone number 412, a customer email address 414, and customer payment information 416. It should be noted that an order record can be associated with other attributes as well. Each of these attributes has been discussed above with respect to FIG. 2. In one embodiment, that one or more of the billing address information 408, shipping address information 410, phone number information 412, email address information 414, and payment information 416 can be stored within the customer record as default values.

Once an order has been generated, the order data 120 for the order is transmitted to the logistics manager 126. The order data 120 can be automatically transmitted to the logistics manager 126 once the order has been generated or can be transmitted based upon receiving an input from a user. The shipping order generator 134 and the receiver ticker generator 136 analyze the order data 120 and transform this data into a shipping order 128 and receiver ticket 130, respectively. For example, shipping order generator 134 extracts at least the order ID 202, and shipping address 210 from the received order data 120. In some embodiments, extraction of the order ID 202 is optional. In other embodiments, the product information 320, customer name 404, customer ID 206, customer phone number 212, and/or customer email address 214 are also extracted from the order data 120.

The shipping order generator 134 generates an electronic shipping order/form utilizing the extracted information and stores this form as shipping order data 128. However, the shipping order is generated such that only non-private information is viewable and private information such as customer name, contact information, order ID, etc. is not provided on the order 128 or at least made inaccessible to the delivery person. For example, the shipping order generator 134 generates encoded data that facilitates anonymous communication between a customer and a delivery person, and to verify the legitimacy of the customer. This encoded data is machine readable or machine-only readable and cannot be deciphered by a human.

In one embodiment, the encoded data comprises a pointer to private data associated with the customer stored in the customer data 118 and/or order data 120. In another embodiment, the encoded data comprises actual private data associated with an order. The data is encoded within a graphical object that is generated by the logistics managers 126. One example of a graphical object comprising encoded data is a matrix or two-dimensional bar code. In this example, data such as a pointer (e.g., shipping order ID or order ID) or a customer's private data (e.g., order ID, name, phone number, and/or the like) can be encoded utilizing black, white, and/or color pixels. It should be noted that any encoding mechanism can be utilized to encode a pointer/identifier and a customer's private data such that the encoded can only be processed by an information processing system.

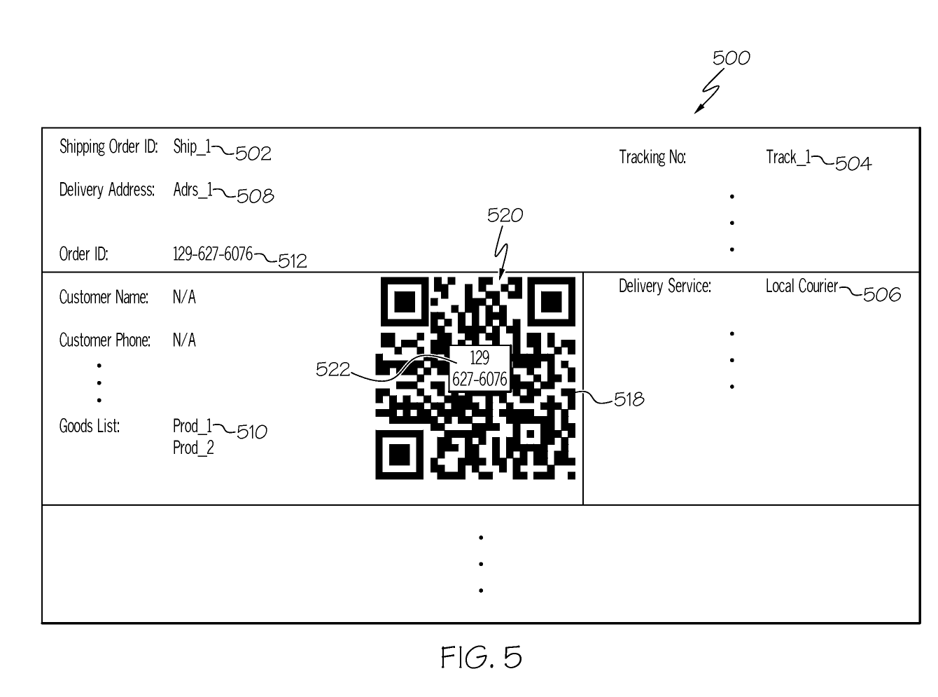

FIG. 5 shows one example of a shipping form 500 created by the shipping order generator 134. In this example, an electronic shipping form 500 has been created based on order data 120 associated with an order. The shipping form 500 comprises non-private information such as a shipping order ID 502, which uniquely identifies the shipping order; a tracking number 504, which can be used to monitor the delivery status of the package; delivery service type 506 information (e.g., local courier, next day delivery, standard deliver, etc.); delivery address 508, which identifies where the package is to be delivered; unique identifiers 510 of the goods associated with the package; and optionally the unique identifier 512 associated with the order being shipped, which in this example is not being considered as private information. It should be noted that in other embodiments, the order ID 512 is considered private and is not provided on the shipping order, or is at least encoded such that a human is unable to read the order ID. It should also be noted that the shipping order 500 is not limited to the attributes shown in FIG. 5.

FIG. 5 also shows that private data such as a customer's name and phone number have not been provided in corresponding fields 514, 516 (which do not need to be included on the form 500), at least in a human readable form, on the shipping order form. However, a graphical object 518, such as a two-dimensional bar code, comprising encoded data 520 has been provided within the shipping order 500. In one embodiment, the encoded data 520 comprises a pointer linked to customer data 118, a customer's name, a customer's phone number, an order ID, and/or the like.

Any visual/graphical encoding mechanism can be used to generate the encoded data 520 within the graphical object 518. For example, data can be encoded utilizing various patterns, locations, and sizes of different colors, shapes, and characters. The patterns and locations of the colors, shapes, and characters represent the data being encoded. In some embodiments, the graphical object 518 can comprise human readable data (non-encoded data) such as the order ID 522 (when considered non-private data) associated with the shipping order. In one embodiment, the shipping order generator 134 stores an image of the graphical object 518 as part of the shipping order data 128. The shipping order generator 134 can also store a signature, hash, fingerprint, etc. of the graphical object 518 as part of the shipping order data 128 as well. One advantage of the shipping order 500 shown in FIG. 5 is that private data such as customer name, customer phone number, etc. is either not included in the shipping order or is encoded such that a human is not able to recognize or view the private data.

Once the shipping order, or at least the graphical object 518 with the encoded data 520, has been generated, the receiver ticket generator 136 generates a receiver ticket, which is stored as part of the receiver ticket data 130. A receiver ticket comprises a graphical object with encoded data corresponding to the graphical object 518 generated for the shipping form. The receiver ticket can also comprises an optional unique verification value such as a personal identification number (PIN), which is discussed in greater detail below. A random number generator can be utilized to generate the unique verification value.

In one embodiment, the logistics manager 126 electronically and wirelessly transmits the electronic shipping form to the delivery person via the logistics interface 114 of the person's electronic device 106. In another embodiment, a physical copy of the electronic shipping form can be printed and obtained by the delivery person. It should be noted that the server 108 can transmit the electronic shipping form to a separate logistics server, which then transmits the form to the device 106 associated with the delivery person. The shipping order manager 136 electronically and, in some embodiments, wirelessly transmits the receiver ticket data 130 comprising a receiver ticket to the customer via the logistics interface 112 on the customer's electronic device 104.

As noted above, the electronic shipping form provided to the delivery person does not comprise the customer's name or phone number. Therefore, when the delivery person needs to contact the customer, he/she initiates an anonymous communication session with the user via the logistics interface 114. The communication session is anonymous since the delivery person is not provided with contact information associated with the customer. In one embodiment, the delivery person establishes a communication session with the customer by selecting at least one graphical object presented within the interface 114.

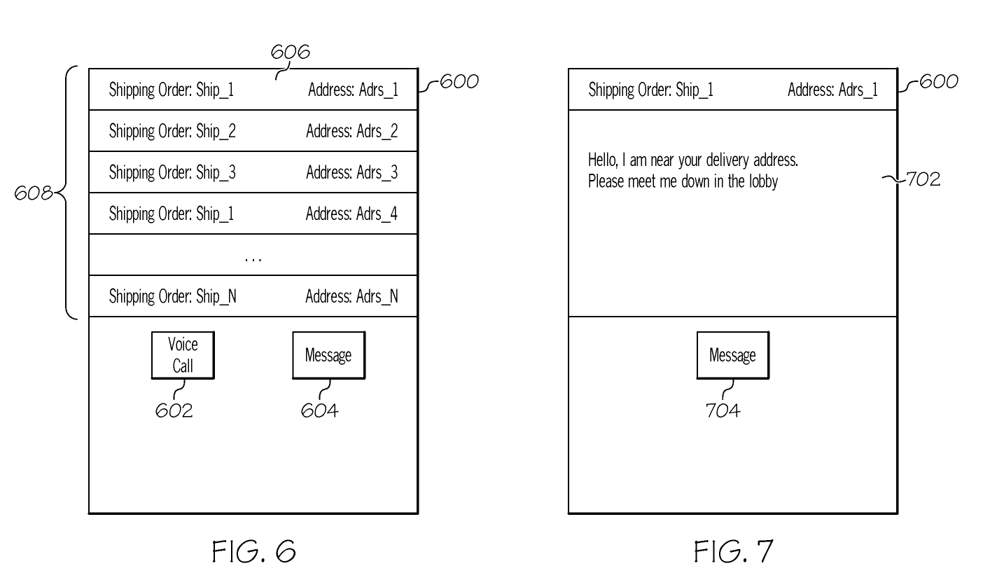

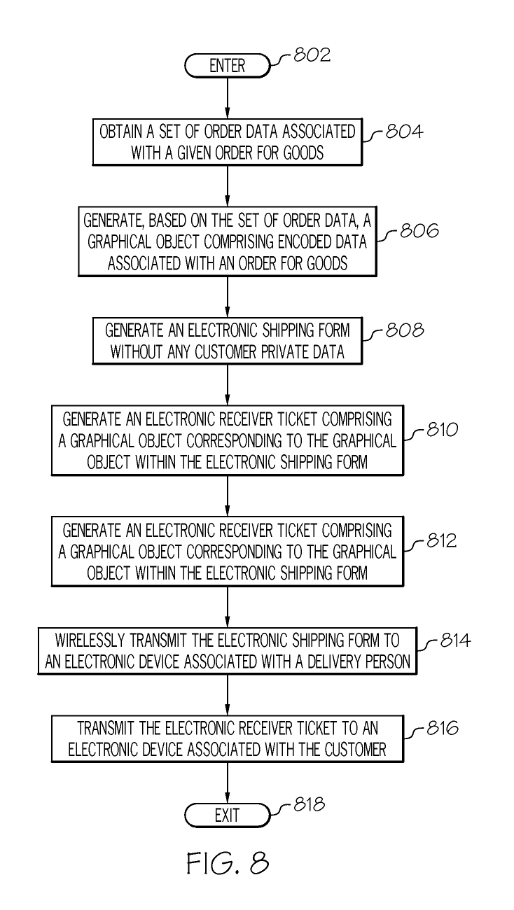

For example, FIG. 6 shows an interface 600 presenting a first communication-based graphical object 602 and a second communication-based graphical object within the interface 114. The first communication-based graphical object 602 initiates a voice and/or video call with the customer, while the second communication-based graphical object 604 initiates a text-based communication such as a Short-Message-Service message, an email, etc. with the customer. Selection of a graphical object 602, 604 instructs the interface 600 to prompt the user to select at least one shipping order 606 from a list of shipping orders 608 presented within the interface 600. Once the order 606 is selected, a communication session is established with the customer associated with the selected order 606. If the delivery person selected the second graphical object 604, the interface 114 presents the user with a messaging window 702 to send text-based messages to the customer, as shown in FIG. 7. The delivery person enters the messages and selects a graphical object 704 to submit the message to the customer.

In another embodiment, the list of shipping orders 608 can be presented to the user with a separate instance of the graphical objects 602, 604 being displayed with each shipping order 606 in the list 608. In this embodiment, the delivery person is only required to select the graphical object 602, 604 of the specific shipping order 606 for which the communication session is to be initiated. In yet another embodiment, the delivery person selects a shipping order 606 of interest, which dynamically updates the interface 114 with information from the shipping order including the graphical object 518 comprising the encoded data 520. The delivery person is able to select the graphical object 518 to a initiate communication session with the customer.

In one additional embodiment, the first and second communication-based graphical objects 602, 604 are presented to the user within the interface 114 after the interface 114 has been dynamically updated with information from the shipping order. In this embodiment, the second communication-based graphical object 604 is presented with the messaging window 702 so that the delivery person only needs to enter a text-based message therein and select a submit button to initiate a text-based communication session with the customer. In other words, the delivery person is not required to first select the second communication-based graphical object 604 prior to being presented with the messaging window.

It should be noted that if the delivery person has a physical copy of the shipping order, the delivery person uses the logistics interface 114 to scan the graphical object 518 via an imaging device (e.g., camera) of the electronic device 106 to initiate the communication session. For example, the scanning of the graphical object 518 causes the logistics interface 114 to present the communication-based graphical objects 602, 604 discussed above. When the delivery person selects one of the communication-based graphical objects 602, 604, a communication session is established with the customer associated with shipping order.

In one embodiment, the communication manager 138 establishes and manages the communication session between the electronic device 106 of the delivery person and the electronic device 104 of the customer. For example, when the delivery person selects one of the presented communication options 602, 604 the logistics interface 114 transmits a communication request to the communication manager 138 comprising at least an identifier associated with the customer such as the shipping order ID; the order ID; the encoded graphical object 518; a signature, hash, or fingerprint of the encoded graphical object 518; and/or the like. The communication request can also comprise a unique identifier and/or communication address of the delivery person electronic device 106, and a communication request type (e.g., voice call, video call, text-based message, etc.). In an embodiment, where the delivery person selects the text-based communication option the communication request can also comprise the content of the text-based message itself.

The communication manager 138 receives the communication request and identifies a communication address based on the information within the request. For example, the communication request comprises an identifier associated with the customer such as the shipping order ID; the order ID; the encoded graphical object 518; a signature, hash, or fingerprint of the encoded graphical object 518; and/or the like. The communication manager 138 searches the customer data 118, order data 120, and/or shipping order data 128 for the entry/record comprising the identifier. Once the entry/record is located the communication manager 138 identifies the communication address (e.g., phone number, messaging address, etc.) of the customer associated with the entry/record. The communication address can be located within the entry/record or within another entry/record linked thereto. In an embodiment where the user communication address is encoded within the graphical object 518, the communication manager 138 only needs to decode the graphical object 518 to obtain the communication address.

The communication manager 138 utilizes the communication address to establish the communication session between the delivery person's device 106 and the customer's device 104. In one embodiment, communication manager 138 establishes a communication tunnel or link between the device's 106 such that any voice or data packets sent between the device's flow from the originating device through the communication manager 138 to the recipient device. In another embodiment, if the delivery person is requesting a voice call with the customer, the logistics interface 114 at the delivery person's device 106 places a voice call to the communication manager 138 using a communication address of the communication manager 138. At least the identifier (e.g., shipping order ID; the order ID; the encoded graphical object 518; a signature, hash, or fingerprint of the encoded graphical object 518) discussed above is sent to the communication manager 138 as part of the voice call. Once the communication address of the customer is identified, the communication manager 138 forwards the delivery person's voice call to the communication address of the customer device 104 thereby establishing a voice call between the devices 104, 106. Alternatively, the communication manager 138 can first establish a voice call itself to the communication address of the customer device 104 and bridge the voice call received from the delivery person device 106 with the voice call placed to the customer device 104.

In yet another embodiment, if the delivery person has requested a text-based communication with the customer, the logistics interface 114 of the delivery person device 106 sends the text-based communication to the communication address of the communication manager 138. The communication manager 138 receives this communication from the delivery person device 106 along with the identifier discussed above (e.g., shipping order ID; the order ID; the encoded graphical object 518; a signature, hash, or fingerprint of the encoded graphical object 518). Once the communication address of the customer device 104 has been identified, the communication manager 138 forwards the text-based communication received from the delivery person device 106 to the communication address of the customer device 104. Alternatively, the communication manager 138 generates a new message comprising the message body from the received text-based communication. The communication manager 138 then sends this new message to the communication address of the customer device 104.

The customer receives the text-based communication forwarded/sent from the communication manager 138 and presents the communication to the user via the logistics interface 112 or any other interface on the device 104. The user replies to the communication manager 138 by selecting an option to transmit a reply text-based communication to the delivery person. In response to the user selecting this option, the logistics interface 112 at the user device 104 transmits the reply text-based communication to the communication manager 138 similar to that discussed above with respect to the delivery person device 106. The reply text-based communication not only comprises a message from the user to be sent to the delivery person but also comprises an identifier similar to that discussed above with respect to the communication sent from the delivery person. The communication manager 138 utilizes this identifier to transmit the reply text-based communication to the delivery person device 106.

In one embodiment, the identifier included within a communication from the electronic devices 104, 106 is an anonymous communication address generated by the communication manager 138. This anonymous communication address is mapped to the actual communication address of the delivery person device 106 by the communication manager 138. The communication manager 138 embeds/attaches the anonymous communication address to the text-based communication message received from the electronic device 104, 106. When the communication manager 138 transmits the text-based communication message received from a device 104, 106 to another device 104, 106, the recipient device also receives the embedded/attached anonymous communication address. The anonymous communication address can be viewable and/or hidden from the customer.

When the customer or delivery person replies to the communication, the anonymous communication address is transmitted along with the reply text-based communication to the communication manager 138. The communication manager 138 searches a communication address map stored within the communication data 132 comprising mappings between anonymous communication addresses and actual communication address of the devices 104, 106. This allows the communication manager 138 to identify the actual communication address of the intended recipient device 104, 106. The communication manager 138 then transmits the reply text-based communication to the recipient device 104, 106 similar to that discussed above.

When the delivery person arrives at the delivery destination, he/she captures an image of the encoded graphical object in the customer's electronic or physical receiver ticket. As noted above, the receiver ticket comprises an encoded graphical object corresponding to the encoded graphical object 518 of the shipping form. In one embodiment, the customer opens the logistics interface 112 (or any other interface) on his/her electronic device 104 and selects an option to display the receiver ticket. In another embodiment, the communication manager 138 monitors the location of the delivery person device 106 via one or more location mechanisms (e.g., Global Positioning System, triangulation, trilateralization, etc.). When the communication manager 138 determines that the delivery person device 106 is within a given distance threshold from the delivery address, the communication manager 138 sends an electronic notification to the customer device 104. This electronic notification is presented to the user via the logistics interface 112 (or any other interface) indicating that the delivery person is near the delivery address. In response to receiving notification, the logistics interface 112 automatically locates the receiver ticket(s) on the customer device 104 (or stored on a remote information processing system) associated with the package(s) being currently being delivered and automatically displays this ticket(s) via the interface 112.

When the delivery person device 106 captures/scans an image of the encoded graphical object of the receiver ticket, the logistics interface 114 of the device 106 wirelessly transmits the captured image to the communication manager. Alternatively, the logistics interface 114 can generate data representing encoded graphical object. For example, the interface 114 can generate a signature, hash, fingerprint, etc. of the encoded graphical object within the receiver ticket and transmits this data to the logistics manager 126. In one embodiment, the shipping order ID and/or order ID can also be transmitted to the logistics manager 126 as well.

The logistics manager 126 receives the image or representative data of the encoded graphical object from the delivery person device 106. If the manager 126 receives an image of the encoded graphical object itself, the manager 126 decodes the graphical object to obtain a first set of data. As noted above, this data can include a pointer to customer data 118 which can include private data associated with the customer such as a customer's name, a customer's phone number, an order ID, and/or the like. The logistics manager 126 also retrieves the encoded graphical object from the associated shipping order. The shipping order associated with the encoded graphical object received from the delivery person device 106 can be identified from an identifier transmitted along with the object such as the shipping identifier and/or identified from the data obtained by decoding the received graphical object. The communication manager 138 decodes the encoded graphical object from the shipping order to obtain a second set of data. The manager 138 compares the first and second sets of data to determine if they match (at least within a given threshold). If the first and second sets of data match, the logistics manager 126 determines that the correct customer has been identified and is authorized to receive the package being delivered.

In an embodiment where the logistics manager 126 receives data representing the encoded graphical object of the receiver ticket (or generates the representative data for a received encoded graphical object), the logistics manager 126 generates representative data for the encoded graphical object of the related shipping order. The communication manager 138 compares both sets of representative data to determine if they match (at least within a given threshold). If the both sets of representative data match each other, the logistics manager 126 determines that the correct customer has been identified and is authorized to receive the package being delivered.

The logistics manager 126 sends an electronic notification to the logistics interface 114 of the delivery person device 106 notifying the delivery person whether or not the correct customer has been located and is authorized to receive the package. The logistics manager 126 instructs the logistics interface 114 of the delivery person device 106 (or the customer device 104) to display a prompt for the customer to enter his/her verification value provided as part of the receiver ticket. Once the user has entered this value, the delivery person device 106 (or the customer device 104) wireless transmits this value to the logistics manager 126. The manager 126 compares this received value to the verification value stored as part of the shipping order data or customer order data associated with the shipping order. If the values match, the logistics manager 126 sends an electronic notification to the logistics interface 114 of the delivery person device 106 notifying the delivery person whether or not the correct customer has been located and is authorized to receive the package. Once the customer has been verified, the delivery person can transfer the package to the customer.

FIG. 8 is an operational flow diagram illustrating one example of securing private data in a logistics environment. The operational flow diagram of FIG. 8 begins at step 802 and flows directly to step 804. The logistics manager 126, at step 804, obtains a set of order data 120 associated with a given order for goods. The logistics manager 126, at step 806, generates a graphical object 518 comprising encoded data 520 associated with the order for goods. The encoded data 520 within the graphical object 518 is machine-only readable. The logistics manager 126, at step 808, generates an electronic shipping form 500. The electronic shipping form 500 comprises at least a delivery address associated with the order and the graphical object. Private data associated with a customer of the order is inaccessible to a human via the electronic shipping form 500.

The logistics manager 126, at step 812 generates an electronic receiver ticket comprising a graphical object corresponding to the graphical object 518 within the electronic shipping form 500. The logistics manager 126, at step 814, wirelessly transmits the electronic shipping form 500 to an electronic device 106 associated with a delivery person. The logistics manager 126, at step 816, transmits the electronic receiver ticket to an electronic device 104 associated with the customer. The control flow exits at step 818.

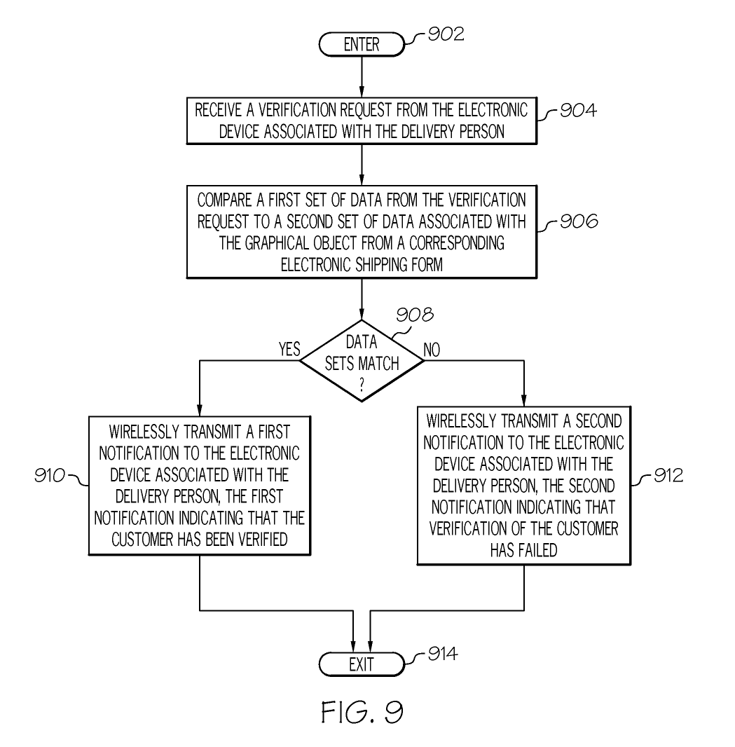

FIG. 9 is an operational flow diagram illustrating another example of securing private data in a logistics environment. The operational flow diagram of FIG. 9 begins at step 902 and flows directly to step 904. The logistics manager 126, at step 904, receives a verification request from an electronic device 106 associated with an delivery person. The verification request comprises a first set of data associated with the graphical object from the receiver ticket. The logistics manager 126, at step 906, compares the first set of data to a second set of data associated with the graphical object 518 from the electronic shipping form 500. The logistics manager 126, at step 908, determines if the first and second sets of data match each other. Based on the first and second sets of data matching, the logistics manager 126, at step 910, wirelessly transmitting a first notification to the electronic device 106 associated with the delivery person indicating that the customer has been verified. Based on the first and second sets of data failing to match, the logistics manager 126, at step 912, wirelessly transmits a second notification to the electronic device 106 associated with the delivery person indicating that verification of the customer has failed. The control flow exits at step 914.

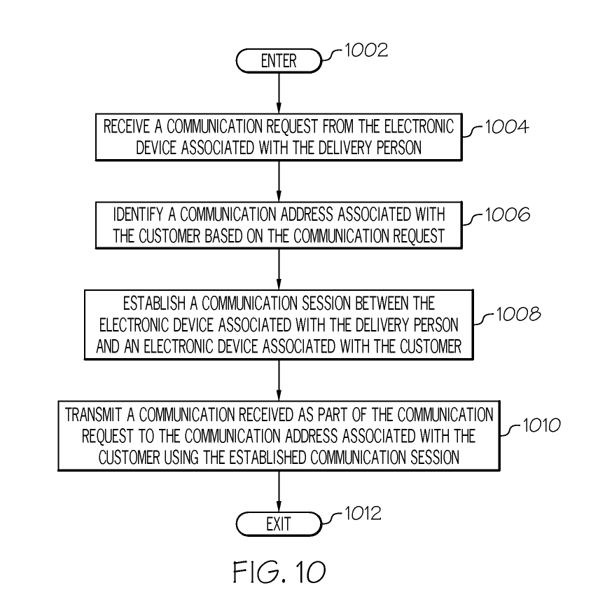

FIG. 10 is an operational flow diagram illustrating another example of securing private data in a logistics environment. The operational flow diagram of FIG. 10 begins at step 1002 and flows directly to step 1004. The logistics manager 126, at step 1004, receives a communication request from the electronic device 106 associated with the delivery person. The logistics manager 126, at step 1006, identifies a communication address associated with the customer based on the communication request. The logistics manager 126, at step 1008, establishes a communication session between the electronic device 106 associated with the delivery person and an electronic device 104 associated with the customer. The logistics manager 126, at step 1010, transmits a communication received as part of the communication request to the communication address associated with the customer using the established communication session. The control flow exits at step 1012.

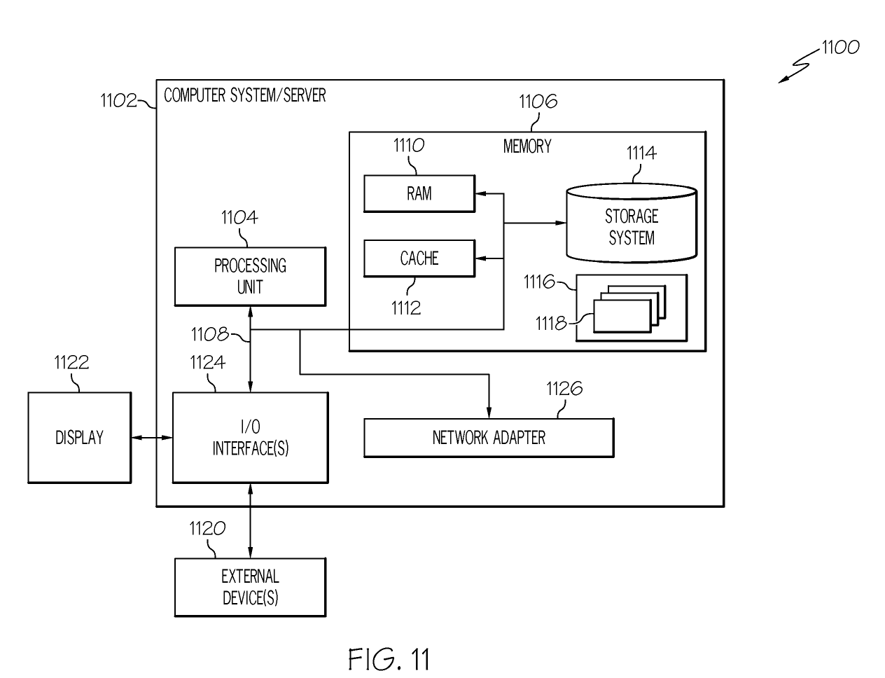

Referring now to FIG. 11, this figure is a block diagram illustrating an information processing system that can be utilized in embodiments of the present disclosure. The information processing system 1102 is based upon a suitably configured processing system configured to implement one or more embodiments of the present disclosure (e.g., server 108). Any suitably configured processing system can be used as the information processing system 1102 in embodiments of the present disclosure. The components of the information processing system 1102 can include, but are not limited to, one or more processors or processing units 1104, a system memory 1106, and a bus 1108 that couples various system components including the system memory 1106 to the processor 1104.

The bus 1108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Although not shown in FIG. 11, the main memory 1106 includes the order manager 116, logistics manager 126, communication manager 138, their components, and the various types of data 118, 120, 122, 128, 130, 132, shown in FIG. One or more of these components 120 can reside within the processor 1104, or be a separate hardware component. The system memory 1106 can also include computer system readable media in the form of volatile memory, such as random access memory (RAM) 1110 and/or cache memory 1112. The information processing system 1102 can further include other removable/non-removable, volatile/non-volatile computer system storage media. By way of example only, a storage system 1114 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 1108 by one or more data media interfaces. The memory 1106 can include at least one program product having a set of program modules that are configured to carry out the functions of an embodiment of the present disclosure.

Program/utility 1116, having a set of program modules 1118, may be stored in memory 1106 by way of example, and not limitation, as well as an operating system, one or more application programs, other program modules, and program data. Each of the operating system, one or more application programs, other program modules, and program data or some combination thereof, may include an implementation of a networking environment. Program modules 1118 generally carry out the functions and/or methodologies of embodiments of the present disclosure.

The information processing system 1102 can also communicate with one or more external devices 1120 such as a keyboard, a pointing device, a display 1122, etc.; one or more devices that enable a user to interact with the information processing system 1102; and/or any devices (e.g., network card, modem, etc.) that enable computer system/server 1102 to communicate with one or more other computing devices. Such communication can occur via I/O interfaces 1124. Still yet, the information processing system 1102 can communicate with one or more networks such as a local area network (LAN), a general wide area network (WAN), and/or a public network (e.g., the Internet) via network adapter 1126. As depicted, the network adapter 1126 communicates with the other components of information processing system 1102 via the bus 1108. Other hardware and/or software components can also be used in conjunction with the information processing system 1102. Examples include, but are not limited to: microcode, device drivers, redundant processing units, external disk drive arrays, RAID systems, tape drives, and data archival storage systems.

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit”,” “module”, or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer maybe connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for securing private data in a logistics environment, the method comprising:
generating a graphical object comprising encoded data associated with an order for goods, wherein the encoded data within the graphical object is machine-only readable;
generating an electronic shipping form, the electronic shipping form comprising at least a delivery address associated with the order and the graphical object, wherein private data associated with a customer is inaccessible to a human via the electronic shipping form; and
wirelessly transmitting the electronic shipping form to an electronic device associated with a delivery person.

2. The method of claim 1, wherein generating a graphical object comprises:
analyzing a set of information associated with the order;
selecting at least a portion of the set of information associated with the order; and
encoding the portion of the set of information within the graphical object.

3. The method of claim 2, wherein the set of information comprises at least one of a unique identifier associated with the order, a communication address associated with the customer, and a name of the customer.

4. The method of claim 1, wherein the graphical object is a two-dimensional barcode.

5. The method of claim 1, further comprising:
receiving a communication request from the electronic device associated with the delivery person;
identifying a communication address associated with the customer based on the communication request; and
establishing a communication session between the electronic device associated with the delivery person and an electronic device associated with the customer.

6. The method of claim 1, further comprising:
generating an electronic receiver ticket comprising a graphical object corresponding to the graphical object within the electronic shipping form; and
transmitting the electronic receiver ticket to an electronic device associated with the customer.

7. The method of claim 6, further comprising:
receiving a verification request from the electronic device associated with the delivery person, the verification request comprising a first set of data associated with the graphical object from the electronic receiver ticket;
comparing the first set of data to a second set of data associated with the graphical object from the electronic shipping form;
based on the first and second sets of data matching, wirelessly transmitting a first notification to the electronic device associated with the delivery person, the first notification indicating that the customer has been verified; and
based on the first and second sets of data failing to match, wirelessly transmitting a second notification to the electronic device associated with the delivery person, the second notification indicating that verification of the customer has failed.

8. An information processing system for securing private data in a logistics environment, the information processing system comprising:
a memory;
a processor operably coupled to the memory; and
a logistics manager operably coupled to the memory and the processor, the logistics manager configured to perform a method comprising
generating a graphical object comprising encoded data associated with an order for goods, wherein the encoded data within the graphical object is machine-only readable;
generating an electronic shipping form, the electronic shipping form comprising at least a delivery address associated with the order and the graphical object, wherein private data associated with a customer is inaccessible to a human via the electronic shipping form; and
wirelessly transmitting the electronic shipping form to an electronic device associated with a delivery person.

9. The information processing system of claim 8, wherein generating a graphical object comprises:
analyzing a set of information associated with the order;
selecting at least a portion of the set of information associated with the order; and
encoding the portion of the set of information within the graphical object.

10. The information processing system of claim 9, wherein the set of information comprises at least one of a unique identifier associated with the order, a communication address associated with the customer, and a name of the customer.

11. The information processing system of claim 8, wherein the method further comprises:
receiving a communication request from the electronic device associated with the delivery person;
identifying a communication address associated with the customer based on the communication request; and
establishing a communication session between the electronic device associated with the delivery person and an electronic device associated with the customer.

12. The information processing system of claim 8, wherein the method further comprises:
generating an electronic receiver ticket comprising a graphical object corresponding to the graphical object within the electronic shipping form; and
transmitting the electronic receiver ticket to an electronic device associated with the customer.

13. The information processing system of claim 8, wherein the method further comprises:
receiving a verification request from the electronic device associated with the delivery person, the verification request comprising a first set of data associated with the graphical object from the electronic receiver ticket;
comparing the first set of data to a second set of data associated with the graphical object from the electronic shipping form;
based on the first and second sets of data matching, wirelessly transmitting a first notification to the electronic device associated with the delivery person, the first notification indicating that the customer has been verified; and
based on the first and second sets of data failing to match, wirelessly transmitting a second notification to the electronic device associated with the delivery person, the second notification indicating that verification of the customer has failed.

14. A computer program product for securing private data in a logistics environment, the computer program product comprising:
a storage medium readable by a processing circuit and storing instructions for execution by the processing circuit for performing a method comprising:
generating a graphical object comprising encoded data associated with an order for goods, wherein the encoded data within the graphical object is machine-only readable;
generating an electronic shipping form, the electronic shipping form comprising at least a delivery address associated with the order and the graphical object, wherein private data associated with a customer is inaccessible to a human via the electronic shipping form; and
wirelessly transmitting the electronic shipping form to an electronic device associated with a delivery person.

15. The computer program product of claim 14, wherein generating a graphical object comprises:
analyzing a set of information associated with the order;
selecting at least a portion of the set of information associated with the order; and
encoding the portion of the set of information within the graphical object.

16. The computer program product of claim 15, wherein the set of information comprises at least one of a unique identifier associated with the order, a communication address associated with the customer, and a name of the customer.

17. The computer program product of claim 14, wherein the graphical object is a two-dimensional barcode.

18. The computer program product of claim 14, wherein the method further comprises:
receiving a communication request from the electronic device associated with the delivery person;
identifying a communication address associated with the customer based on the communication request; and
establishing a communication session between the electronic device associated with the delivery person and an electronic device associated with the customer.

19. The computer program product of claim 14, wherein the method further comprises:
generating an electronic receiver ticket comprising a graphical object corresponding to the graphical object within the electronic shipping form; and
transmitting the electronic receiver ticket to an electronic device associated with the customer.

20. The computer program product of claim 19, wherein the method further comprises:
receiving a verification request from the electronic device associated with the delivery person, the verification request comprising a first set of data associated with the graphical object from the receiver ticket;
comparing the first set of data to a second set of data associated with the graphical object from the electronic shipping form;
based on the first and second sets of data matching, wirelessly transmitting a first notification to the electronic device associated with the delivery person, the first notification indicating that the customer has been verified; and
based on the first and second sets of data failing to match, wirelessly transmitting a second notification to the electronic device associated with the delivery person, the second notification indicating that verification of the customer has failed.
